(19) United States
(12) Patent Application Publication
(10) Pub. No.: US 2021/0116721 A1
(43) Pub. Date: Apr. 22, 2021

(54) PARALLAX ERROR CORRECTING SYSTEM

(71) Applicant: Harvey Fishman, Menlo Park, CA (US)

(72) Inventor: Harvey Fishman, Menlo Park, CA (US)

(21) Appl. No.: 16/670,769

(22) Filed: Oct. 31, 2019

Related U.S. Application Data
(60) Provisional application No. 62/923,715, filed on Oct. 21, 2019.

(51) Int. Cl. G02C 7/08; G02C 11/00

(52) U.S. Cl. CPC G02C 7/083; G02C 11/10

(57) ABSTRACT

A parallax error correcting system is disclosed herein. In one embodiment the system may comprise a smart lens consisting of a liquid crystal layer that may be made opaque, and that may become partially cleared when touched. In another embodiment the system may comprise a manually-operated device that may be positioned over the glasses frame of a wearer to determine the optical center of corrective lenses and prevent parallax error. The device may further comprise a central opening that may be manipulated by an eye care professional based on feedback given by the wearer, and a means for attaching the device to the glasses frame or lenses to prevent reading errors. The system may further comprise an electronic interface and a software application, to provide for additional features and accuracy of readings.

### TECHNICAL FIELD OF THE INVENTION

The present invention relates in general to optical calibrating devices, and, more specifically, to a parallax error correcting system.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Glasses, which may also be called eyeglasses or spectacles, often comprise wearable devices consisting of hard plastic lenses held in front of a person's eyes by a frame. The hard plastic lenses, usually called corrective lenses, often comprise clear convex or concave surfaces designed to refract light to improve visual acuity or correct other eye disorders. The frames often comprise a pair of lens holders connected by a bridge, for sitting on a wearer's nose, and a pair of arms, for resting on a wearer's ears.

Parallax is the effect whereby the position or direction of an object appears to differ when viewed from different positions. Because of the nature of human binocular vision, the total parallax between the two eyes allows for effective depth perception. The parallax points of each of the two lenses in a pair of glasses, which may be called the optical centers of the lenses, must be carefully set so as to maintain this effect in combination with the parallax points of the wearer's eyes, and incorrect parallax settings in the lenses can lead to such symptoms as observational errors and dizziness.

A number of methods exist to assist with the setting of the optical centers in corrective lenses. One basic method involves holding a small light in front of the lens and marking the spot where the centers of the images reflected from the front and rear surfaces overlap, and may be done while the user is wearing the glasses. A common method in use today involves the implementation of a phoropter, which is a multi-lensed device through which a user looks while an eye care professional changes settings and asks the user for subjective feedback on the settings that give the best vision.

Certain automated devices have also been developed for finding the optical centers of corrective lenses. One such device may comprise a frame that is attached to the glasses frame when worn by a user. The device may then account for the way the glasses are worn by the user, including distance of the lens from the eyes and any natural tilt in the worn frame, by readings taken from a camera device against identification points attached to the device frame. The camera device records how the glasses are worn on the user and records the position of the frames relative to the user's pupils so that the optical center of the frames can be determined.

Another such automated device comprises an at-home vision test in the form of an eyepiece physically attached to a user' s smartphone, in combination with a smartphone application installed on the phone, that allows a user's refractive error to be measured based on subjective inputs given by the user in response to device inquiries. Such a device actually allows a user to determine their own refractive errors, pupillary distance, and optical centers themselves, without the intervention of an eye care professional, though such readings by lay persons may not be as accurate as those made by a trained professional.

There is a need in the art for a parallax error correcting system that is employed by a trained eye care professional for reliability of readings, but that more accurately determines the optical center of corrective lenses while maintaining a low cost and small form factor for effectiveness of use. It is to these ends that the present invention has been developed.

### BRIEF SUMMARY OF THE INVENTION

To minimize the limitations in the prior art, and to minimize other limitations that will be apparent upon reading and understanding the present specification, the present invention describes a parallax error correcting system.

It is an objective of the present invention to provide a parallax error correcting system that may comprise a manual device.

It is another objective of the present invention to provide a parallax error correcting system that may comprise a wearable device.

It is another objective of the present invention to provide a parallax error correcting system that may comprise a partially adhesive film.

It is another objective of the present invention to provide a parallax error correcting system that may comprise a plurality of reference points for measurement.

It is another objective of the present invention to provide a parallax error correcting system that may comprise a central opening.

It is another objective of the present invention to provide a parallax error correcting system that may comprise a smart film.

It is another objective of the present invention to provide a parallax error correcting system that may comprise a liquid crystal display.

It is another objective of the present invention to provide a parallax error correcting system that may comprise a liquid crystal display lens.

It is another objective of the present invention to provide a parallax error correcting system that may comprise a laser pointer.

It is another objective of the present invention to provide a parallax error correcting system that may comprise a post-dilation light blocker.

It is another objective of the present invention to provide a parallax error correcting system that may comprise an electronic interface.

It is another objective of the present invention to provide a parallax error correcting system that may comprise wireless connectivity.

It is another objective of the present invention to provide a parallax error correcting system that may comprise a software application.

It is another objective of the present invention to provide a parallax error correcting system that may comprise a resilient material of construction.

It is another objective of the present invention to provide a parallax error correcting system that may comprise a flexible material of construction.

It is another objective of the present invention to provide a parallax error correcting system that may comprise an antimicrobial layer.

It is another objective of the present invention to provide a parallax error correcting system that may comprise an antimicrobial material of construction.

It is another objective of the present invention to provide a parallax error correcting system that may comprise a protective coating layer.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates a top isometric perspective view of a first embodiment of a parallax error correcting system, as contemplated by the present disclosure;

FIG. 2 illustrates a front perspective view of a first embodiment of a parallax error correcting system, as contemplated by the present disclosure;

FIG. 3 illustrates a side perspective view of a first embodiment of a parallax error correcting system, as contemplated by the present disclosure;

FIG. 4 illustrates an isometric perspective view of a first embodiment of a parallax error correcting system mounted on an exemplary glasses frame, as contemplated by the present disclosure;

FIG. 5 illustrates a front perspective view of a second embodiment of a parallax error correcting system, as contemplated by the present disclosure;

FIG. 6 illustrates a front perspective view of a second embodiment of a parallax error correcting system mounted on an exemplary glasses frame, as contemplated by the present disclosure;

FIG. 7 illustrates an isometric perspective view of a third embodiment of a parallax error correcting system, as contemplated by the present disclosure;

FIG. 8 illustrates a front perspective view of a third embodiment of a parallax error correcting system placed in front of an exemplary glasses frame and having a transparent display, as contemplated by the present disclosure;

FIG. 9 illustrates a front perspective view of a third embodiment of a parallax error correcting system placed in front of an exemplary glasses frame and having an opaque display;

FIG. 10 illustrates a front perspective view of a third embodiment of a parallax error correcting system placed in front of an exemplary glasses frame and having an opaque display with a clear spot, as contemplated by the present disclosure;

FIG. 11 illustrates an isometric perspective view of a fourth embodiment of a parallax error correcting system, as contemplated by the present disclosure;

FIG. 12 illustrates a front perspective view of a fourth embodiment of a parallax error correcting system exemplary glasses frame having a transparent smart lens, as contemplated by the present disclosure;

FIG. 13 illustrates a front perspective view of a fourth embodiment of a parallax error correcting system exemplary glasses frame having an opaque smart lens; and

FIG. 14 illustrates a front perspective view of a fourth embodiment of a parallax error correcting system exemplary glasses frame having an opaque smart lens with a clear spot, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

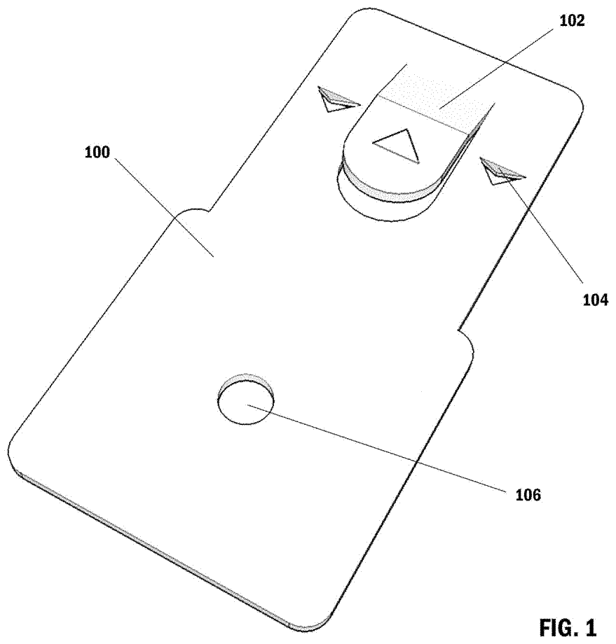

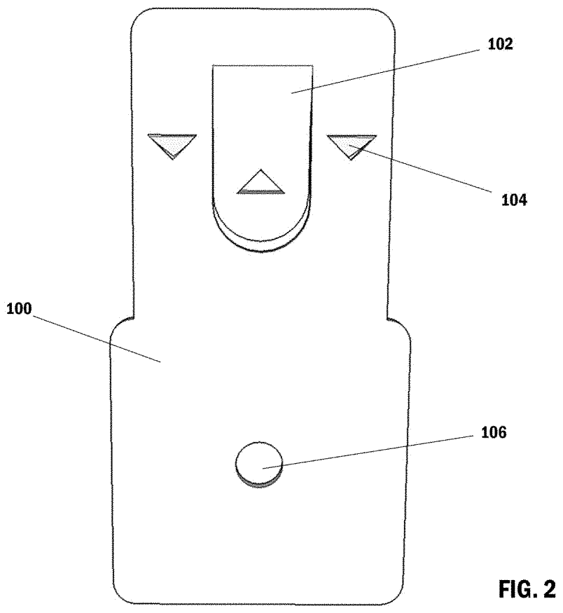

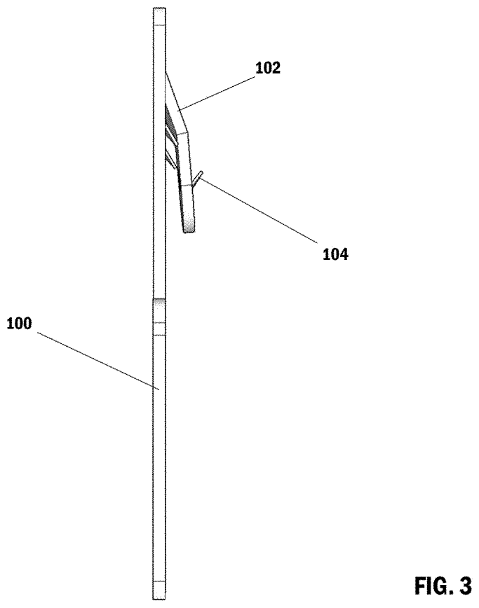

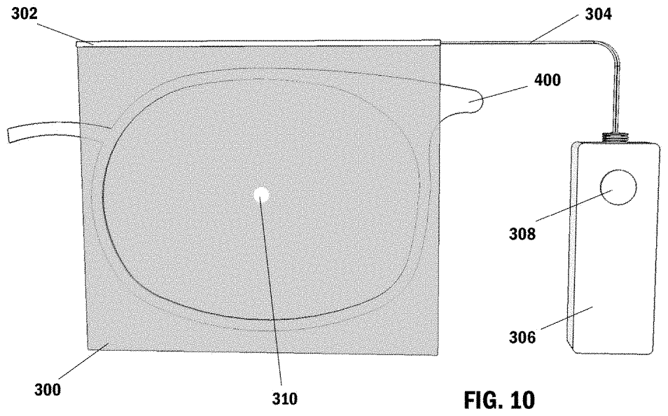

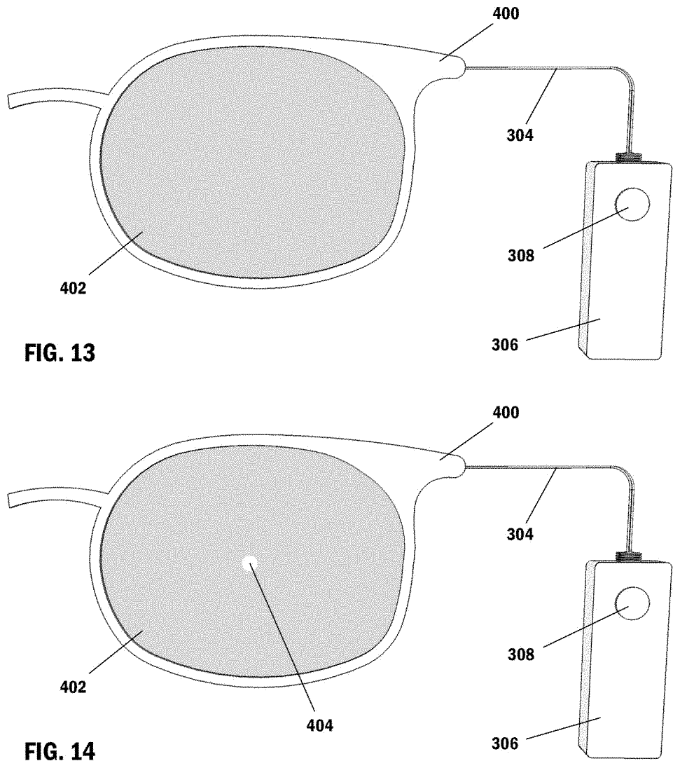

The illustrations of FIGS. 1-14 illustrate a parallax error correcting system, as contemplated by the present disclosure. In one embodiment the system may comprise a smart lens consisting of a liquid crystal layer that may be made opaque, and that may become partially cleared when touched. In another embodiment the system may comprise a manually-operated device that may be positioned over the glasses frame of a wearer to determine the optical center of corrective lenses and prevent parallax error. The device may further comprise a central opening that may be manipulated by an eye care professional based on feedback given by the wearer, and a means for attaching the device to the glasses frame or lenses to prevent reading errors. The system may further comprise an electronic interface and a software application, to provide for additional features and accuracy of readings.

The illustrations of FIGS. 1-4 illustrate a first embodiment of a parallax error correcting system, as contemplated by the present disclosure. In a first embodiment, the parallax error correcting device may comprise a main body 100 having a frame clip 102, a plurality of locking notches 104, and a central opening 106.

The main body 100 may comprise a resilient material of construction having solid or flexible characteristics, and may be substantially shaped so as to hang from or attach to a glasses frame 400 on a first end while having the second end positioned over the approximate center of the lenses. The frame clip 102 and plurality of locking notches 104 may be located near the first end of the main body 100, and the central opening 106 may be located near the second end of the main body 100.

The frame clip 102 may be substantially shaped so as to fit over an exemplary glasses frame 400 and reversibly engage the main body 100 to the exemplary glasses frame 400. The plurality of locking notches 104 may then lock the main body 100 to the exemplary glasses frame 400 in such a way as to allow for intended adjustments in the positioning of the main body 100 relative to the exemplary glasses frame 400 while preventing unintended adjustments of the main body 100.

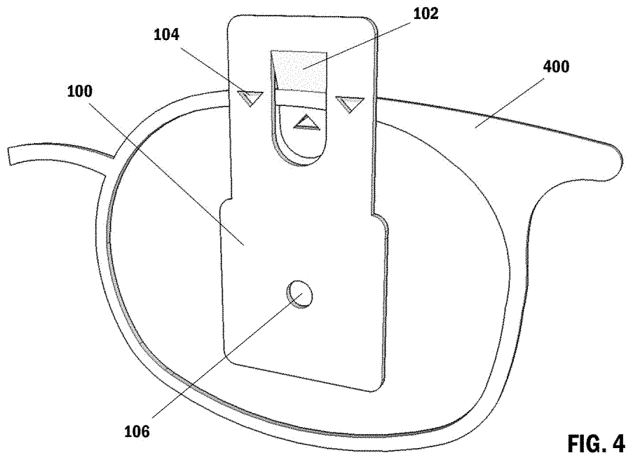

To begin using the first embodiment of the parallax error correcting system a user may wear the exemplary glasses frame 400 400, and an eye care professional may then place the main body 100 onto the exemplary glasses frame 400, as shown in FIG. 4, such that the main body 100 is attached to the exemplary glasses frame 400 by the frame clip 102 and plurality of locking notches 104 while the central opening 106 is placed, generally, over the center of the glasses lenses. The user may then provide feedback to the eye care professional as the position of the main body 100 is adjusted until the user can clearly view an object through the central opening 106.

Once the user is able to completely visualize the object through the central opening 106 the position of the main body 100 may be recorded relative to the exemplary glasses frame 400 so as to determine the optical center of the corrective lenses.

The main body 100 may further comprise an electronic interface, such as a means for electronic or digital communication with a secondary device or a software application, to more accurately determine the position of the main body 100 relative to the exemplary glasses frame 400 and corrective lenses.

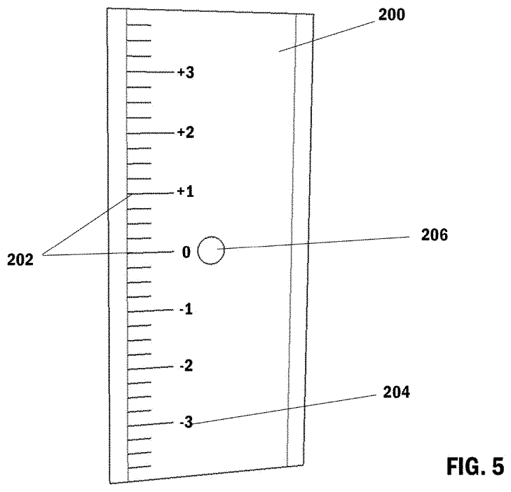

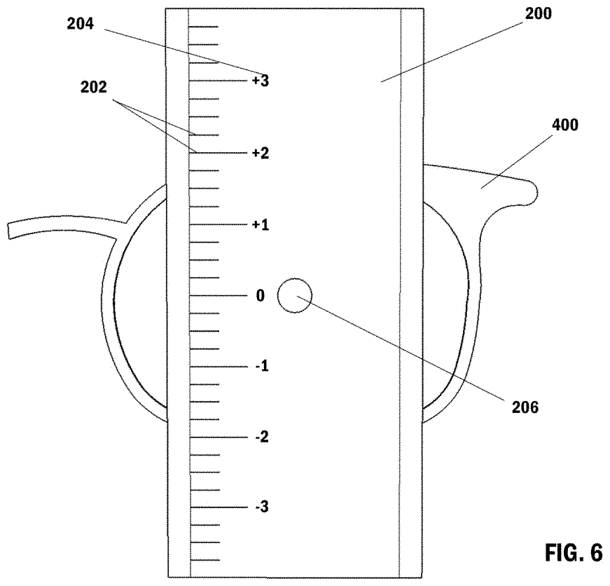

The illustrations of FIGS. 5-6 illustrate a second embodiment of a parallax error correcting system, as contemplated by the present disclosure. In a second embodiment, the parallax error correcting device may comprise a main body 200 having an adhesive surface, a plurality of graduated marks 202, a plurality of reference points 204, and a central opening 206.

The main body 200 may comprise a resilient material of construction having solid or flexible characteristics, and may be substantially shaped so as to attach to a glasses frame 400 while having the central opening 206 positioned over the approximate center of the lenses. The central opening 206 may be positioned near the center of the main body 200, and the plurality of graduated marks 202 and the plurality of reference points 204 may be positioned at advantageous points throughout the main body 200 so as to provide positional reference to the main body 200.

The main body 200 may be substantially shaped so as to fit over an exemplary glasses frame 400 and reversibly engage the corrective lenses of the exemplary glasses frame 400. The adhesive surface of the main body 200 may then engage the main body 200 to the exemplary glasses frame 400 in such a way as to allow for intended adjustments in the positioning of the main body 200 relative to the corrective lenses while preventing unintended adjustments of the main body 200.

To begin using the second embodiment of the parallax error correcting system a user may wear the exemplary glasses frame 400, and an eye care professional may then place the main body 200 onto the exemplary glasses frame 400, as shown in FIG. 6, such that the main body 200 is attached to the corrective lenses by the adhesive surface while the central opening 206 is placed, generally, over the center of the glasses lenses. The user may then provide feedback to the eye care professional as the position of the main body 200 is adjusted until the user can clearly view an object through the central opening 206.

Once the user is able to completely visualize the object through the central opening 206 the position of the main body 200 may be recorded relative to the exemplary glasses frame 400 using the plurality of graduated marks 202 and the plurality of reference points 204 so as to determine the optical center of the corrective lenses.

The main body 200 may further comprise an electronic interface, such as a means for electronic or digital communication with a secondary device or a software application, to more accurately determine the position of the main body 200 relative to the exemplary glasses frame 400 and corrective lenses.

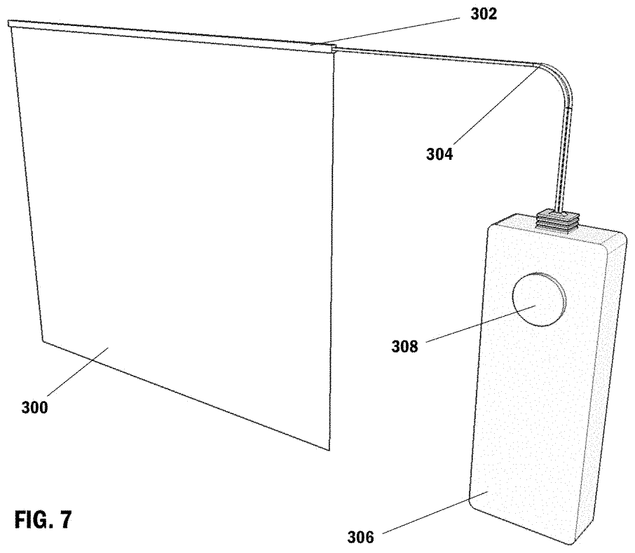

The illustrations of FIGS. 7-10 illustrate a third embodiment of a parallax error correcting system, as contemplated by the present disclosure. In a third embodiment, the parallax error correcting device may comprise a main body 300 having a support frame 302, a plurality of electrical connections 304, a control module 306, and an activating mechanism 308. The activating mechanism 308 may cause an opacity change in the main body 300, resulting in the main body 300 having an opaque appearance.

The main body 300 may comprise a resilient material of construction having solid or flexible characteristics, and may be substantially shaped so as to hang from or attach to the support frame 302 and be positioned over or in front of the approximate center of the lenses.

The main body 300 may further comprise a mounting frame, as described in the first embodiment, or an adhesive surface, as described in the second embodiment, to allow for intended adjustments in the positioning of the main body 300 relative to the exemplary glasses frame 400 while preventing unintended adjustments of the main body 300.

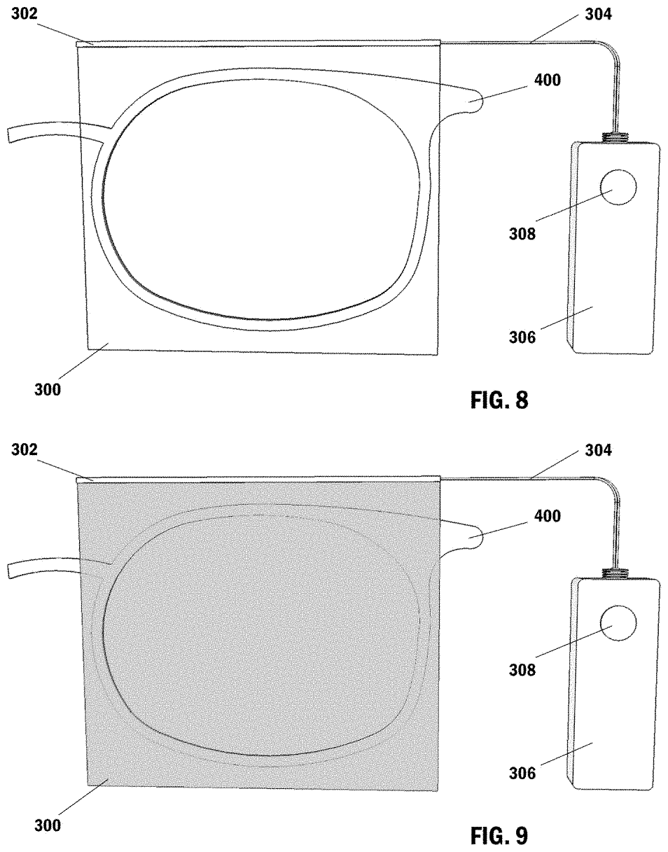

To begin using the third embodiment of the parallax error correcting system a user may wear the exemplary glasses frame 400, and an eye care professional may then place the main body 300 onto the exemplary glasses frame 400, as shown in FIG. 8, such that the main body 300 is attached to the corrective lenses by the mounting frame or adhesive surface. The eye care professional may then activate the activating mechanism 308 to cause the main body 300 to become opaque. The eye care professional or the user may then touch the main body 300 causing a clear central opening 310 to appear on the opaque surface of the main body 300. The user may then provide feedback to the eye care professional as the position of the central opening 310 on the main body 300 is adjusted until the user can clearly view an object through the central opening 310.

Once the user is able to completely visualize the object through the central opening 310 the position of the central opening 310 relative to the main body 300, and the position of the main body 300 relative to the exemplary glasses frame 400, may be recorded so as to determine the optical center of the corrective lenses.

The main body 300 may further comprise an electronic interface, such as a means for electronic or digital communication with a secondary device or a software application, to more accurately determine the position of the main body 300 relative to the exemplary glasses frame 400 and corrective lenses.

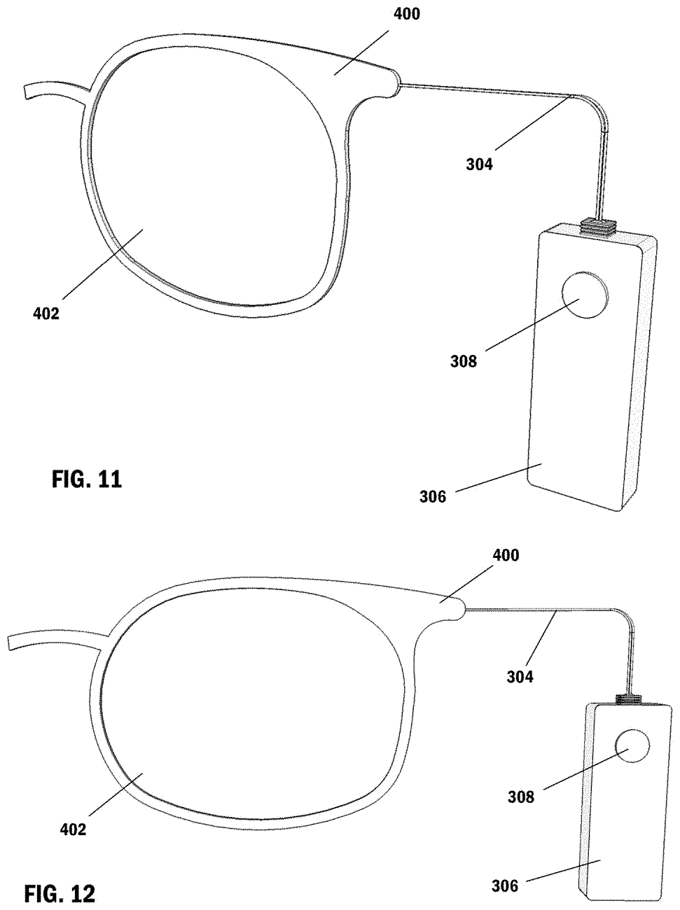

The illustrations of FIGS. 11-14 illustrate a fourth embodiment of a parallax error correcting system, as contemplated by the present disclosure. In a fourth embodiment, the parallax error correcting device may comprise an exemplary glasses frame 400 having a plurality of smart lenses 402, a plurality of electrical connections 304, a control module 306, and an activating mechanism 308. The activating mechanism 308 may cause an opacity change in the plurality of smart lenses 402, resulting in the plurality of smart lenses 402 having an opaque appearance.

The exemplary glasses frame 400 may comprise a resilient material of construction having solid or flexible characteristics, and may be substantially shaped as a pair of glasses to be worn on the face of a user. The plurality of smart lenses 402 may be installed within the exemplary glasses frame 400, and may comprise a clear lens formed from liquid crystal-based material or having a liquid crystal layer installed thereon.

To begin using the fourth embodiment of the parallax error correcting system a user may first wear the exemplary glasses frame 400. The eye care professional may then activate the activating mechanism 308 to cause the plurality of smart lenses 402 to become opaque. The eye care professional or the user may then touch the plurality of smart lenses 402 causing a clear central opening 404 to appear on the opaque surface of the plurality of smart lenses 402. The user may then provide feedback to the eye care professional as the position of the central opening 404 on the plurality of smart lenses 402 is adjusted until the user can clearly view an object through the central opening 404.

Once the user is able to completely visualize the object through the central opening 404 the position of the central opening 404 relative to the plurality of smart lenses 402, and the position of the exemplary glasses frame 400 relative to the wearer's face, may be recorded so as to determine the optical center of the corrective lenses.

The fourth embodiment of a parallax error correcting system may further comprise a plurality of accessories for additional functionality such as, for example, a laser pointer, a plurality of orienting devices, and wireless connectivity. A laser pointer may, for example, be installed on the arms of the exemplary glasses frame 400 and may project a light onto a surface that the wearer may focus on to determine the optical center of the lenses. The plurality of orienting devices may be projections on the exemplary glasses frame 400 that may position and stabilize the glasses frame 400 on the face of the wearer so as to reduce measurement errors. The wireless connectivity, which may be Bluetooth connectivity, may wirelessly connect the exemplary glasses frame 400 to a proprietary software application or other computing or controlling device.

In one embodiment of a parallax error correcting system the main body 300 and the plurality of smart lenses 402 may comprise any appropriate clear material that can be made reversibly opaque. As an example, and without limiting the scope of the present invention, the opacity-changing material may comprise nanocrystals, nanocrystals with amorphous metal oxides, photonic crystals, photonic crystals with periodic dielectric materials, transparent conductive electrodes, liquid crystal displays, solar cells, organic light emitting diodes, silver nanowires, graphene, or combinations thereof.

The parallax error correcting system may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the parallax error correcting system may be substantially constructed of one or more materials of plastic, acrylic, polycarbonate, steel, aluminum, brass, fiberglass, carbon fiber, or combinations thereof. In some embodiments the various components of the device may be coated, lined, or otherwise insulated to prevent contamination of the device. In one embodiment the material of construction may vary from one component to the next within the system.

In one embodiment the parallax error correcting system may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A parallax error correcting system, comprising:
a main body;
a control mechanism;
a reversibly-opaque material; and
an activating mechanism;
wherein said main body is connected to said control mechanism;
wherein said reversibly-opaque material is clear;
wherein said activating mechanism activates said control mechanism;
wherein said control mechanism causes said reversibly-opaque material to become opaque; and
wherein a clear spot is reversibly formed on said reversibly-opaque material.

2. The invention of claim 1,
wherein said main body comprises a material frame;
wherein said reversibly-opaque material comprises a material sheet; and
wherein said material sheet is attached to said material frame.

3. The invention of claim 2,
wherein said material frame further comprises a glasses frame adapter.

4. The invention of claim 2,
wherein said material sheet further comprises an adhesive layer.

5. The invention of claim 2,
wherein said clear spot is movable by touching and dragging with a user's finger.

6. The invention of claim 2,
wherein said clear spot is movable by controlling with said control mechanism.

7. The invention of claim 2,
wherein said material frame is attached to said control mechanism by a physical connection.

8. The invention of claim 2,
wherein said material frame is attached to said control mechanism wirelessly.

9. The invention of claim 2, further comprising:
a proprietary software;
wherein said proprietary software receives a plurality of data points from a plurality of sensors installed on and within said material frame and said material sheet.

10. The invention of claim 9,
wherein said proprietary software controls the opacity of said material sheet and said clear spot.

11. The invention of claim 1,
wherein said main body comprises an exemplary glasses frame;
wherein said reversibly-opaque material comprises a plurality of smart lenses; and
wherein said plurality of smart lenses are installed within and attached to said exemplary glasses frame.

12. The invention of claim 11,
wherein said clear spot is movable by touching and dragging with a user's finger.

13. The invention of claim 11,
wherein said clear spot is movable by controlling with said control mechanism.

14. The invention of claim 11,
wherein said exemplary glasses frame is attached to said control mechanism by a physical connection.

15. The invention of claim 11,
wherein said exemplary glasses frame is attached to said control mechanism wirelessly.

16. The invention of claim 11,
wherein said exemplary glasses frame further comprises a laser pointer.

17. The invention of claim 11,
wherein said exemplary glasses frame further comprises a plurality of positioning and stabilizing arms.

18. The invention of claim 11, further comprising:
a proprietary software;
wherein said proprietary software receives a plurality of data points from a plurality of sensors installed on and within said exemplary glasses frame and said plurality of smart lenses.

19. The invention of claim 18,
wherein said proprietary software controls the opacity of said plurality of smart lenses and said clear spot.

20. The invention of claim 11, further comprising:
an antimicrobial layer.
